(19) United States
(12) Patent Application Publication
(10) Pub. No.: US 2005/0082167 A1
(43) Pub. Date: Apr. 21, 2005

(54) Glass electrode

(76) Inventors: Yasukazu Iwamoto, Kyoto (JP); Shinji Takeichi, Kyoto (JP); Hiromi Okawa, Kyoto (JP)

Correspondence Address: Snell & Wilmer L.L.P., Suite 1200, 1920 Main Street, Irvine, CA, 92614-7230, US

(21) Appl. No.: 10/900,567

(22) Filed: Jul. 28, 2004

Related U.S. Application Data
(63) Continuation-in-part of application No. 10/892,916, filed on Jul. 16, 2004.

(30) Foreign Application Priority Data
Jul. 28, 2003 (JP) P2003-280776

(51) Int. Cl. G01N 27/26

(52) U.S. Cl. 204/433

(57) ABSTRACT

In order to provide a lead free and environmental friendly glass electrode, a glass electrode has a responsive glass membrane conjugated with a distal end portion of a stem glass tube. Neither lead nor a lead compound is included in the stem glass tube and one of an alkali metal oxide and an alkali earth metal oxide is provided so that a thermal expansion coefficient of the stem glass tube is within ±20% of that of the glass used for the responsive membrane.

### BACKGROUND OF THE INVENTION

1. Field of the Invention

This invention relates to a glass electrode that has an arrangement wherein a responsive glass membrane is conjugated with a distal end portion of a stem glass tube and that is used for measuring pH or ionic concentration and more particularly an environmentally compatible glass electrode.

2. Description of the Related Art

Glass electrodes that measure pH are made to conjugate a responsive glass membrane sensitive to hydrogen ions with a distal end portion of a stem glass tube as shown in Japan laid-open disclosure public patent bulletin 2003-28829 and Japan laid-open disclosure public patent bulletin HEI10-316436. The responsive glass membrane is dipped in a sample (liquid) to measure pH and then an electromotive force is generated according to a difference of pH between an internal solution of a known pH that is filled in the glass electrode and the sample. The pH value of the sample is obtained by measuring the electromotive force.

The responsive glass membrane is required to use multicomponent glass containing a significant amount of Lithium in order to fully generate an electromotive force. Such a glass has a property that a thermal expansion coefficient is about three times as large as that of an ordinary silica glass. As a result of this, the stem glass tube with which the responsive glass membrane is conjugated is required to use a glass whose thermal expansion coefficient is similar to that of the responsive glass membrane. If there is a significant difference in the thermal expansion coefficient, a crack or the like might be generated due to rapid temperature changes (thermal shock) during a manufacturing process or in use.

As a result, lead glass whose thermal expansion coefficient is similar to that of the glass used for the responsive glass membrane is conventionally used for the stem glass tube. However, lead glass contains significant lead oxide that is a harmful substance and the lead oxide might have an adverse affect on the environment due to elution into acid or alkali.

Thus the prior art has not provided an environmentally friendly glass electrode without lead.

### SUMMARY OF THE INVENTION

A glass electrode in accordance with the present claimed invention is arranged so that a responsive glass membrane is conjugated with a distal end portion of a stem glass tube, and characterized in that neither lead nor a lead compound is included in the glass that forms the stem glass tube and at least either one of an alkali metal oxide and an alkali earth metal oxide is provided in a predetermined amount. As a result, a thermal expansion coefficient of the glass used for the stem glass tube is within ±20% of that of the glass used for the responsive glass membrane.

Since a responsive glass membrane contains Lithium as mentioned above, and neither lead nor a lead compound is included in the glass that forms the stem glass tube, it is possible to include Lithium in a predetermined amount so that a thermal expansion coefficient of the glass used for the stem glass tube is made within ±20% of that of the glass material used for the responsive glass membrane in order to make the properties of the glass used for the stem glass tube close to that of Lithium and to conjugate the responsive glass membrane with the stem glass tube without difficulty.

From a functional point of view, in such a glass electrode, it is preferable that an internal resistance of the glass used for the stem glass tube is 100 times and greater than an internal resistance of a glass used for the responsive glass membrane.

In accordance with the present invention, since it is possible to exclude lead or lead compound that has been included in a conventional stem glass tube, lead elution is not generated, to thereby avoid any adverse effect on the environment. In addition, since the thermal expansion coefficient of the glass used for the stem glass tube is close to the thermal expansion coefficient of the responsive glass membrane with which the stem glass tube is to be conjugated, it is possible to avoid damage due to thermal shock (temperature changes) during a process of manufacturing the glass and/or a process of product assembling.

### BRIEF DESCRIPTION OF THE DRAWINGS

FIG. 1 is a partially cut away view showing a part of an internal structure of a glass electrode in accordance with one embodiment of the present claimed invention.

FIG. 2 is a magnified view of the A portion in FIG. 1.

FIG. 3 is a schematic diagram of composition of a stem glass in accordance with this embodiment.

FIG. 4 is a property view of the stem glass in accordance with this embodiment.

FIG. 5 is a property performance view of the pH glass in accordance with this embodiment.

FIG. 6 is a partially broken view showing a part of an internal structure of a glass electrode in accordance with another embodiment of the present claimed invention.

### DETAILED DESCRIPTION OF THE INVENTION

Reference will now be made in detail to the preferred embodiments of the invention which set forth the best modes contemplated to carry out the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

A best mode for embodying the present claimed invention will be described with reference to the drawings.

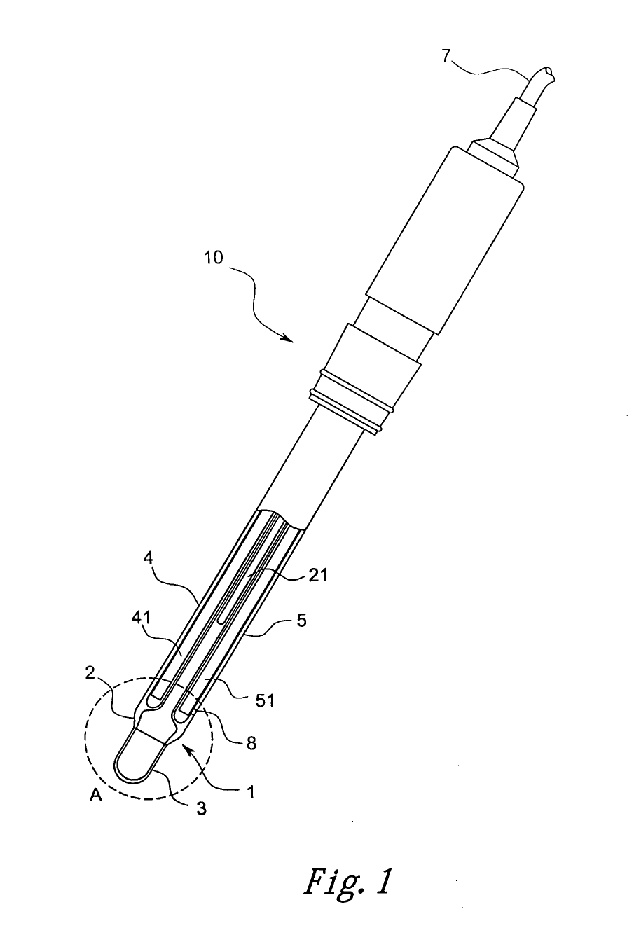

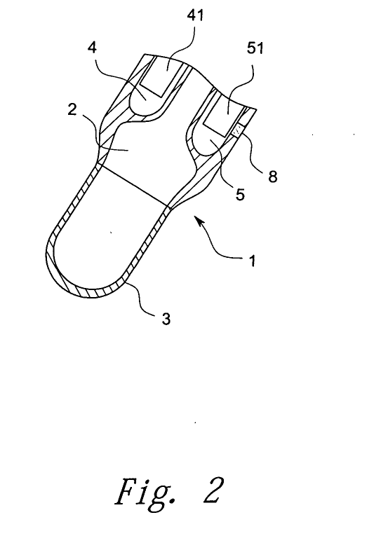

A glass electrode 1 in accordance with one embodiment of the present invention is, as shown in FIG. 1 and FIG. 2, applied to a pH electrode 10 of a combination type and comprises a stem glass tube 2 and a responsive glass membrane 3 that is conjugated with a distal end portion of the stem glass tube 2.

The stem glass tube 2 is in a cylindrical shape and a reference electrode stem glass tube 4 and a temperature compensating electrode stem glass tube 5 are integrally formed with the stem glass tube 2 to surround a periphery of the stem glass tube 2 and the stem glass tube 2 is made to project its distal end portion close to the reference electrode stem glass tube 4. The temperature compensating electrode stem glass tube 5 (as shown in FIG. 2). The responsive glass membrane 3 is conjugated with the distal end portion of the stem glass tube 2. The glass used for the stem glass tube 2, the glass used for the reference electrode stem glass tube 4 and the glass used for the temperature compensating electrode stem glass tube 5 are identical and its composition will be described later.

Each of the stem glass tube 2 and the reference electrode stem glass tube 4 accommodates an internal electrode of the glass electrode 21 and an internal electrode of the reference electrode 41 respectively and a KCI solution of, for example pH 7, is filled in the stem glass tube 2 and the reference electrode stem glass tube 4 as an internal solution. A temperature element 51 that outputs an electronic signal in compliance with ambient temperature is accommodated inside the temperature compensating electrode stem glass tube 5. A lead wire, not shown in the drawings, is connected with the internal electrode of the glass electrode 21, the internal electrode of the reference electrode 41 and the temperature element 51 respectively and each lead wire is bound up in a cable bundle 7 and extends outside from a proximal end portion of the stem glass tube 2 so as to be connected with a pH instrument, not shown in the drawings. A reference number of 8 is a liquid-junction arranged at an appropriate portion of an outer wall of the reference electrode stem glass tube 4.

The responsive glass membrane 3 is made of a multicomponent glass containing Lithium in a cylindrical shape whose distal end portion is formed to be of a general hemispherical shape. In order to conjugate the responsive glass membrane 3 with the stem glass tube 2, the glass used for the responsive glass membrane 3 is made in a molten state in a furnace, for example, kept at one thousand and several hundred degrees Centigrade and the distal end portion of the stem glass tube 2 is dipped in the molten glass followed by being pulled from the molten glass at a predetermined speed.

When the glass electrode 1 of the above arrangement is dipped into a sample to measure its pH, an electromotive force is generated in accordance with a pH difference between the internal solution and the sample and the electromotive force shows up as a difference in potential between the internal electrode of the glass electrode 21 and the internal electrode of the reference electrode 41. Since the electromotive force fluctuates in accordance with temperature, the pH meter body calculates pH of the sample by making use of an output signal value output by the temperature element 51 as a compensation parameter and displays it in addition to the difference in potential.

In this embodiment, the glass (hereinafter referred to as a stem glass) that forms the stem glass tube 2 contains neither lead nor a lead compound and at least one of an alkali metal oxide and an alkali earth metal oxide is contained by a predetermined amount with an intention to make a thermal expansion coefficient of the stem glass within ±20% of that of the glass (hereinafter referred to as pH glass) used for the responsive glass membrane 3. It is more preferable that the thermal expansion coefficient of the stem glass is within ±10% of that of the pH glass.

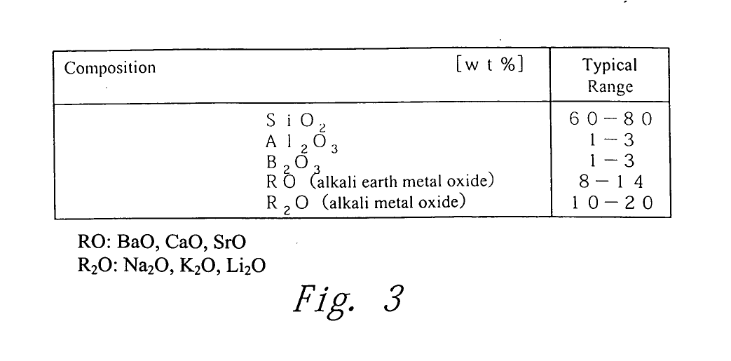

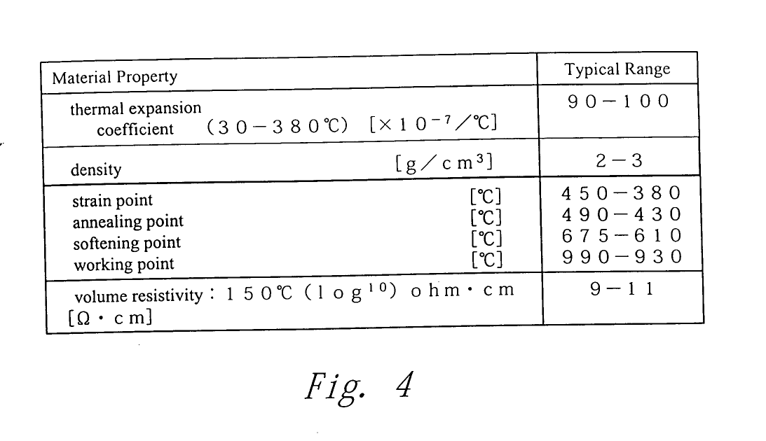

A composition of the stem glass and its properties are shown in FIG. 3 and FIG. 4. As shown in FIG. 3 the alkali earth metal oxide (RO) can be selected from BaO, CaO and SrO and the alkali metal oxide (R₂O) can be selected from Na₂O, K₂O and Li₂O.

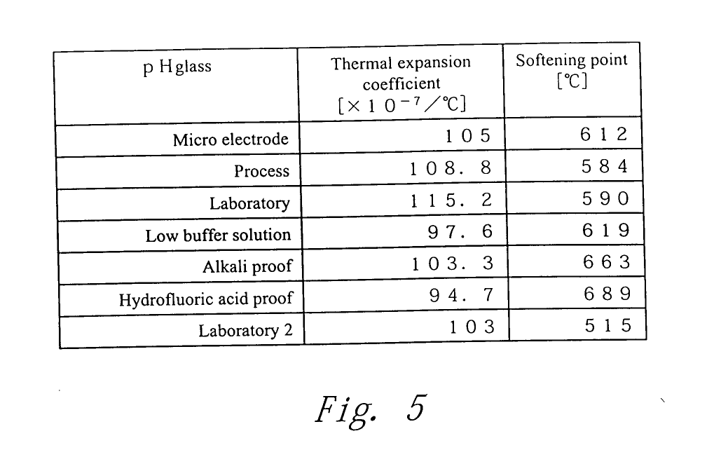

Further thermal properties of the pH glass are shown in FIG. 5. Since there are various kinds of pH glass in use, a typical example will be represented. A resistance value of the pH glass is approximate 10⁷ Ω˜10⁹ Ω in a finished state of the responsive membrane.

As is clear from FIG. 3, the stem glass contains neither lead nor a lead compound (lead oxide). As a result, the stem glass does not elute lead even if dipped in acid or an alkali solution and does not produce an adverse affect on the environment due to releasing lead.

In addition, as is clear from FIG. 4 and FIG. 5, since the thermal expansion coefficient of the stem glass is within ±20% of that of various kinds of the pH glass, damage due to a thermal shock (sudden temperature changes up and down) during a process of forming a glass component or a process of product assembling can be restrained. If the thermal expansion coefficient is over ±20%, a rate of crack occurrence is 15%˜20% and over and a yield ratio is extremely aggravated.

Further, the stem glass is, although not shown in drawings, one hundred times of the pH glass in volume resistivity, thereby not to harm an accuracy of pH measurement.

The present claimed invention is not limited to the above-described embodiment.

For example, in order to reduce the rate of crack occurrence, it is preferable that the thermal expansion coefficient is made within ±10% of the thermal expansion coefficient of the pH glass, more preferably within ±several %. As a result of this, a content ratio of RO (alkali earth metal oxide) or R₂O (alkali metal oxide) may be varied in conformity with the thermal expansion coefficient of the various types of pH glass or either one of RO and R₂O alone may be included.

In addition, Lithium oxide may be included by a predetermined amount (such as 0˜2 wt %) as an alkali metal oxide. Since Lithium glass (glass containing a lot of Lithium) is frequently used as the responsive glass membrane, in case that Lithium is contained as the alkali metal, a chemical bounding force is obtained especially in a connected portion (a connected portion between the responsive glass membrane and the stem glass tube), and the connected portion is hardy and it is unlikely that thermal distortion will occur during a process.

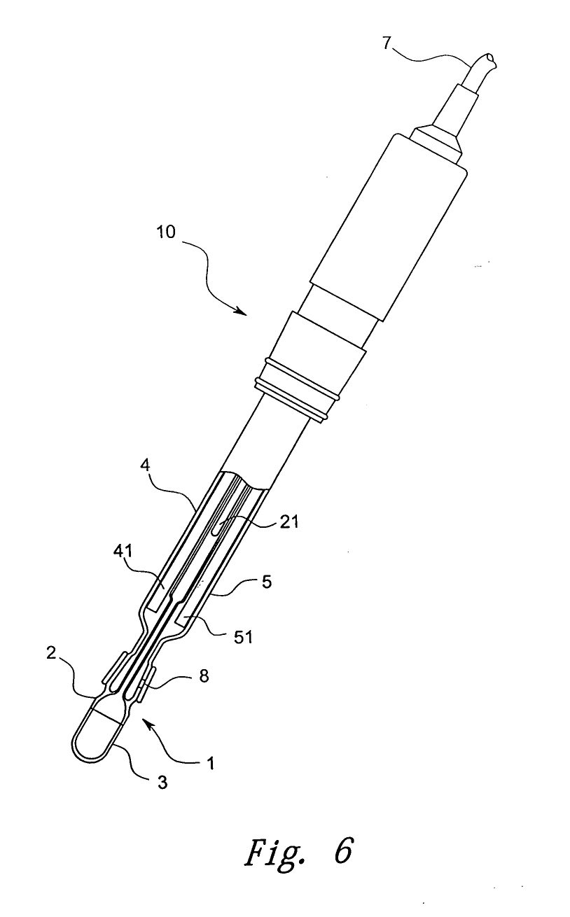

It is a matter of course that the liquid junction 8 may be applied to a shape of a sleeve as shown in FIG. 6, a shape of a pin hole or a shape of a double junction. In FIG. 6 the same reference numbers are given to the components corresponding to the above embodiment.

In addition, the glass electrode is not necessarily integrated into the reference electrode or the temperature compensating electrode. The electrode of the present claimed invention may be applied to a simplicial electrode and then the same operation and effect can be produced Further, it is possible to apply the present claimed invention to not only an electrode for pH measurement but also an electrode for measuring ionic concentration. Finally, the particular shape and configuration of the components in the environmentally friendly glass electrode can be varied to accommodate the particular usage required of the glass electrode.

The present claimed invention may be variously modified without departing from the spirit of the invention.

1. A glass electrode, wherein a responsive glass membrane is conjugated with a distal end portion of a stem glass tube, and characterized by that neither lead nor a lead compound is included in the glass that forms the stem glass tube and at least one of an alkali metal oxide and an alkali earth metal oxide is contained in a predetermined amount in the stem glass tube so that a thermal expansion coefficient of the glass used for the stem glass tube is within ±20% of that of the glass used for the responsive membrane.

2. The glass electrode described in claim 1 wherein an internal resistance of the glass used for the stem glass tube is 100 times or greater than an internal resistance of the glass used for the responsive glass membrane.

3. A glass electrode wherein a responsive glass membrane is conjugated with a distal end portion of a stem glass tube, and characterized by that neither lead nor lead compound is included in the glass that forms the stem glass tube and lithium of a predetermined amount is in the stem glass tube so that a thermal expansion coefficient of the glass used for the stem glass tube is within ±20% of that of the glass used for the responsive membrane.

4. The glass electrode described in claim 3 wherein an internal resistance of the glass used for the stem glass tube is 100 times or greater than an internal resistance of the glass used for the responsive glass membrane.

5. In an improved glass electrode for measurement of an ionic concentration in a sample, the improvement comprising:
a glass stem member having a pre-determined reference solution therein; and
a responsive glass membrane connected to the glass stem member is free of lead and contains one of an alkali metal oxide and an alkali earth metal oxide of a predetermined amount to provide a thermal expansion coefficient within ±10% of the thermal expansion coefficient of the response glass membrane.

6. The glass electrode of claim 5 wherein the responsive glass membrane has a resistance value within an approximate range of 10⁷ Ω˜10⁹ Ω.

7. The glass electrode of claim 5 wherein the glass stem member contains lithium.

8. The glass electrode of claim 5 wherein the alkali metal oxide is selected from one of Na₂O, K₂O and Li₂O and the alkali earth metal oxide is selected from one of BaO, CaO and SrO.
